(19) United States
(12) Patent Application Publication
(10) Pub. No.: US 2012/0167912 A1
(43) Pub. Date: Jul. 5, 2012

(54) TOUCHLESS DENTAL FLOSS DISPENSER

(76) Inventor: Winifred J. Booker, Owings Mills, MD (US)

(21) Appl. No.: 12/981,222

(22) Filed: Dec. 29, 2010

(51) Int. Cl. A61C 15/04

(52) U.S. Cl. 132/322

(57) ABSTRACT

Embodiments described herein relate to an automatic, touchless dental floss dispenser that comprises a housing with a front cover, a sensing mechanism for detecting of an object adjacent the front cover without the object contacting the front cover, a dispensing mechanism for dispensing a predetermined length of floss, and a cutting mechanism for automatically severing the dental floss at measured lengths to ensure proper use and minimize waste of dental floss.

### FIELD OF THE INVENTION

Embodiments described herein relate generally to an automatic, touchless dental floss dispenser, and more specifically to an automatic, touchless dental floss dispenser for dispensing measured lengths of dental floss in an efficient, deliberate and hygienic manner.

### BACKGROUND OF THE INVENTION

It is well known that dentists and oral hygienists strongly recommend flossing as a supplement to brushing to remove plaque and other food particles from between the teeth. Many people do not floss as often as they should due to the inconvenience of carrying dental floss dispensers and the lack of availability of dental floss dispensers in public washrooms. Restaurateurs, hotel establishments, health clubs and operators of service stations with public washroom facilities are concerned with keeping their washrooms clean as well as about providing meaningful amenities for their clientele. Patrons would benefit from being able to use dental floss dispensers in the washrooms, but they want to be assured that the dental floss is supplied in a hygienic manner.

Recent studies reveal that only about 20 percent of the population of North America regularly utilize floss, although it is assumed that between 70 percent and up to 90 percent of all households have at least one dental floss container in their possession. Moreover, it has been noted that there seems to be less of a tendency to want to use a dental floss dispenser that requires the user to hold the dispenser in one hand while dental floss is removed from the dispenser with the other hand, especially in those circumstances where the cutter for the dental floss is exposed and may represent a risk to the fingers of the user.

Advances in the art of dental floss dispensers have been limited to the provision of dispensers for dental floss supplied on spools or in various shaped commercially available containers. Little has been done to provide dental floss dispensers suitable for mounting in public washroom facilities and other commercial environments. With conventional dental floss dispensers, users are free to choose any desired length of dental floss, which usually results in unnecessary waste. This improper use of too much dental floss also makes achieving the oral hygiene task all the more challenging as too much or even too little floss interferes with the desirable efficiency needed to cleanse between the teeth. Since severing dental floss from existing dispensers still involves the manual steps of passing the floss over a small hook and jerking the floss against the hook, a portion of unused dental floss can be contaminated each time the dispenser is used.

It would be desirable to provide an automatic, touchless dental floss dispenser that is convenient, safe and easy to use in commercial environments.

### BRIEF DESCRIPTION OF THE DRAWINGS

FIG. 1 is an illustration of an automatic dental floss dispenser in accordance with an embodiment described herein.

FIG. 2 is another illustration of the automatic dental floss dispenser in accordance with an embodiment described herein.

FIG. 3 is another illustration of the automatic dental floss dispenser in accordance with an embodiment described herein.

### DETAILED DESCRIPTION OF THE INVENTION

Embodiments described herein generally relate to an automatic, touchless dental floss dispenser, and more particularly to an automatic, touchless dental floss dispenser with desired selection options. In the following detailed description, reference is made to the accompanying drawings which form a part hereof, and in which is shown by way of illustration of specific embodiments that may be practiced. These embodiments are described in sufficient detail to enable those of ordinary skill in the art to make and use them, and it is to be understood that structural, logical, or procedural changes may be made to the specific embodiments disclosed.

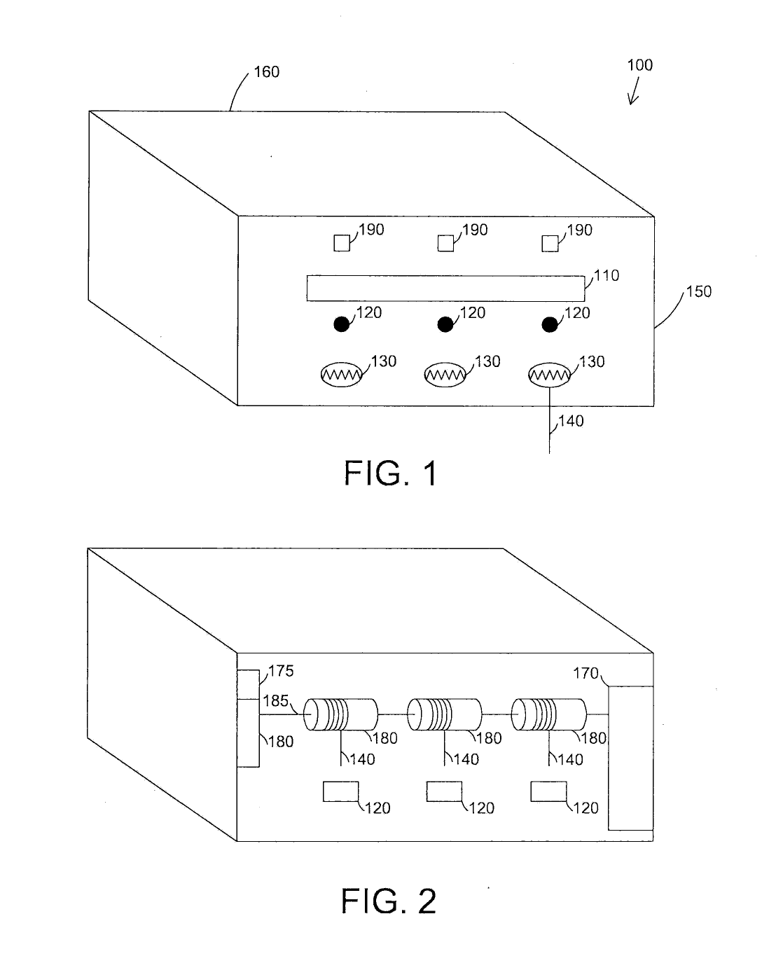

Referring to FIGS. 1 and 2, the automatic, touchless dental floss dispenser 100 comprises a housing 160 with a front cover 150 that is pivotal between open and closed positions. FIG. 1 shows the dental floss dispenser 100 with the front cover 150 in a closed position. FIG. 2 shows the dental floss dispenser 100 without the front cover 150 to illustrate the internal components of the dental floss dispenser 100. The opening of the front cover 150 of the housing 160 allows exposing of the internal components of the dispenser 100 (described below) and resupplying of the dental floss 140 and fixing of any dental floss entanglements.

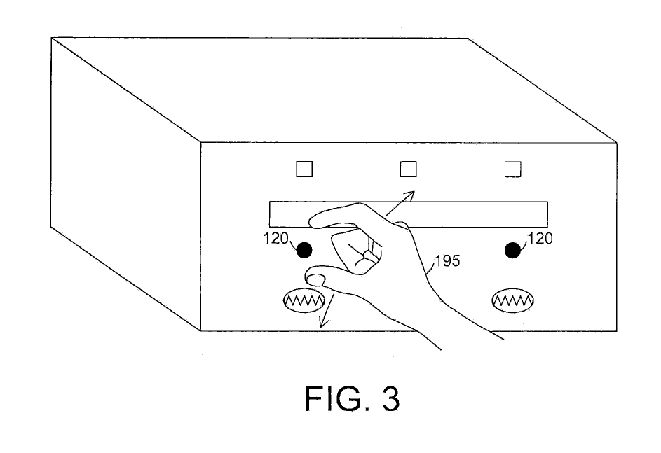

A sensing mechanism 120 is disposed entirely within the interior space of the housing 160 at a location adjacent to the front cover 150 of the housing 160. The sensing mechanism 120 is orientated toward the front cover 150 of the housing 160 to permit detecting of an object, such as a hand waiving 195, using light detection, adjacent the front cover 150 without the object contacting the front cover 150, as shown in FIG. 3. It should be appreciated that any known detection method, such as light, can be used. It should also be appreciated that not just any presence adjacent to the front cover will be detected by the sensing mechanism 120, but only ones that clearly reflect an object's attempt to be detected by the sensing mechanism, e.g., the waiving of a hand within close proximity to the sensing mechanism. A user simply walking by the dispenser 100 would not be a sufficient action to permit the detection of an object.

Once an object is detected, the sensing mechanism 120 signals the dispenser 100 to release a selected strand of dental floss. A user can select the desired dental floss using buttons 190. Each button 190 corresponds to a certain dispensing mechanism 180 which corresponds to a certain type of dental floss 140. The differences between dental flosses may be according to certain flavors, sizes, or any other known distinctions in dental floss. As shown in FIG. 1, at least a portion of the sensing mechanism 120 is accessible and exposed to a user when the front cover 150 is in the closed position.

To release a selected strand of dental floss, a dispensing mechanism 180 dispenses a predetermined length of dental floss 140. The dispensing mechanism 180 is disposed within the housing 160 with the dispensing mechanism 180 and includes a drive roller 185 and a monitor 175. The monitor 175 is engaged with the drive roller 185. As shown in FIG. 2, dental floss 140 is wound on the dispensing mechanism 180 and fed through a plurality of floss guides (not shown) down to the cutting mechanism 130 where the dental floss 140 extends to the exterior of the housing 160 (as shown in FIG. 1). Rotation of the dispensing mechanism 180, which is actuated by the drive roller 185 and monitor 175, causes movement of the dental floss 140 in the downward direction. The dispensing mechanism 180 rotates within the housing 160 while dental floss 140 is moving through the floss guides. It is recognized that other embodiments may use different mechanisms for engaging and advancing dental floss.

The dispenser 100 also includes an electric cord (not shown) or battery power source 170 for powering operation of the dispenser 100. Thus, dispensing mechanism 180 along with drive roller 185 and monitor 175 are powered by either power via the electric cord or from the battery power source 170.

Once the dispensing mechanism has dispensed the predetermined length of dental floss, a cutting mechanism 130 within the dispenser 100 automatically severs the dental floss 140 at the predetermined measured length. The predetermined measured length minimizes waste of dental floss. The cutting mechanism 130 within the dispenser cuts the dental floss 140 when the dental floss 140 is extended to the predetermined length, e.g., 6 inches, 1 foot, etc. It should be appreciated that the dispenser can be preset to cut the dental floss at any desired length. Once the desired predetermined length has been extended, the cutting mechanism 130 is triggered and severs the dental floss 140 at a point between two clamps and cutting edges.

Once severed, the user catches the cut dental floss for use. During use, the dispenser 100 includes a mirror 110 for observing the practice of flossing. Additionally, the housing 160 can have an aperture (not shown) for a receptacle in the dispenser 100 for users to dispose of used lengths of dental floss.

The embodiments described herein provide a number of advantages. For example, the dental floss dispenser 100 delivers dental floss 140 in such a manner that unused dental floss will not be contaminated by human hands. Moreover, the dental floss dispenser 100 is convenient, safe and easy to use in commercial environments. Such a dispenser 100 can also be mounted in public washrooms, used in private bathrooms, or in dentist and oral hygienist's offices or other convenient and visible location. The dispenser 100 can be conveniently, but not limited to, mounted to a mounting surface. The mounting surface is preferably, but not limited to, vertical. Especially when mounted to a vertical mounting surface, dental floss may be removed from the dispenser 100 using a single hand.

This system of making dental floss more available and readily accessible will help to promote better oral hygiene by encouraging the public to practice the routine behavior of employing the use of dental floss between meals. Flossing to prevent tooth decay can prevent the inconvenience, expense, and potential discomfort with which it is commonly associated. The dental floss dispenser 100 will help to lessen, over time, the oral health care burden placed on the state commerce by helping to reduce the frequency of dental caries that occur between the teeth.

Plaque and food particle that become trapped between the teeth are difficult to reach without the use of dental floss. When the process of tooth decay that occurs between the teeth begins it is the most difficult to detect, challenging to treat and more often continues to advance until there is irreversible damage. The use of dental radiographs is necessary to detect interproximal dental caries. This interproximal decay (decay on the smooth surfaces between teeth) requires removal of a significant amount of healthy tooth structure to access the problem areas. Prevention of this type of cavity through flossing can eliminate the destruction of tooth enamel. Any type of tooth decay can lead to the need for fillings but tooth decay between the teeth is especially devastating. This type of tooth destruction can lead to the need for any, or all, of the following dental treatments:
Root Canal Therapy
Crowns
Implants
Bridges
Partial Dentures
Complete Dentures
Extraction of teeth

The dental floss dispenser 100 will help to protect the public by motivating them to have better routine oral health care habits and thus avoiding the pain, suffering and expense brought on by tooth decay that hides between the teeth.

The foregoing description of the embodiments has been presented for purposes of illustration and description. It is not intended to be exhaustive or to limit the embodiments to the precise form disclosed, and other modifications and variations may be possible in light of the above teachings. The embodiments were chosen and described in order to best explain the principles of them and their practical application to thereby enable others skilled in the art to best utilize the invention in various embodiments and various modifications as are suited to the particular use contemplated.

What is claimed as new and desired to be protected by Letters Patent of the United States is:

1. A dental floss dispenser comprising:
a housing with a front cover;
a sensing mechanism for detecting of an object that is substantially adjacent to the front cover;
a dispensing mechanism for dispensing a predetermined length of floss in response to the sensing mechanism detecting an object; and
a cutting mechanism for severing the predetermined length of floss in response to the dispensing mechanism.

2. The dispenser of claim 1, wherein the dispensing mechanism comprises a drive roller and a monitor in driving engagement with the drive roller to dispense the predetermined length of floss.

3. The dispenser of claim 1, wherein the dispensing mechanism, sensing mechanism and cutting mechanism are powered by a battery power source.

4. The dispenser of claim 1, wherein the predetermined length of floss is six inches.

5. The dispenser of claim 1, wherein the dispensing mechanism feeds the floss through a plurality of floss guides to connect to the cutting mechanism where the floss extends to the exterior of the housing.

6. The dispenser of claim 1, further comprising a mirror for observing the practice of flossing.

7. The dispenser of claim 1, further comprising a plurality of buttons for a user to select a desired dental floss.

8. The dispenser of claim 1, further comprising an aperture for a receptacle in the dispenser for users to dispose of used dental floss.

9. A method of using a dental floss dispenser comprising:
detecting of an object adjacent the dispenser without the object contacting the dispenser;
dispensing a predetermined length of floss in response to the detecting step; and
severing the predetermined length of floss in response to the dispensing step.

10. The method of claim 7, further comprising the step of selecting a desired dental floss by pressing one of a plurality of buttons.
